(19) United States
(12) Patent Application Publication
(10) Pub. No.: US 2018/0054641 A1
(43) Pub. Date: Feb. 22, 2018

(54) Method of Livestreaming an Audiovisual Audition

(71) Applicants: Raymond L. Hall, Las Vegas, NV (US); Brandi Marie Weidner, Las Vegas, NV (US); Gary Bordman, Las Vegas, NV (US); Samuel B. Fisher, Saratoga, CA (US); Loeta F. Fisher, Saratoga, CA (US)

(72) Inventors: Raymond L. Hall, Las Vegas, NV (US); Brandi Marie Weidner, Las Vegas, NV (US); Gary Bordman, Las Vegas, NV (US); Samuel B. Fisher, Saratoga, CA (US); Loeta F. Fisher, Saratoga, CA (US)

(21) Appl. No.: 15/239,906

(22) Filed: Aug. 18, 2016

(51) Int. Cl. H04N 21/2743; H04N 21/2187; H04N 21/441; H04N 21/45; H04N 21/475; H04N 21/4223; H04N 21/422; H04N 21/61

(52) U.S. Cl. CPC H04N 21/2743; H04N 21/2187; H04N 21/441; H04N 21/6125; H04N 21/4758; H04N 21/4223; H04N 21/42203; H04N 21/4532

(57) ABSTRACT

A method of livestreaming an audiovisual audition allows a candidate to livestream an audiovisual audition to a talent agency, talent competition, or similar entity. A plurality of computerized kiosks is utilized to capture and livestream the audiovisual audition. The candidate is able to enter personal information to generate a candidate profile on at least one remote server. Audiovisual audition data for the candidate profile is retrieved and livestreamed to an audience a plurality of personal computing (PC) devices through a destination web portal. A voting process is executed to allow the audience to vote for the candidate profile with the plurality of PC devices. An aggregated vote count is calculated by subtracting a plurality of negative votes from a plurality of positive votes to rank the candidate profile amongst other candidate profiles from a particular region or state.

### FIELD OF THE INVENTION

The present invention relates generally to a method for livestreaming an audiovisual audition. More specifically, the present invention is a method of livestreaming an audiovisual audition for submission to a talent agency, talent competition, or similar entity.

### BACKGROUND OF THE INVENTION

Talent competitions typically showcase contests on domestic, statewide, and international levels. Contestants are generally able to perform an activity or showcase a skill in the hopes of winning a prize as well as achieving recognition and fame. Talent competitions have become widespread with a wide variety of activities and skills performed for large audiences. The auditions for these competitions often attract a large number of prospective candidates. Auditions may be held in the form of recorded videos submitted by the candidates in which the candidates display their talents. Live auditions may be held for candidates who are selected after this initial process. Talent competitions may also host live auditions in various locations. However, an inherent issue of this type of audition is the fact that contestants must generally travel large distances without a guarantee of selection for the competitions or even a guarantee of being granted an audition.

The present invention is a method of livestreaming an audiovisual audition for submission to a talent agency, talent competition, or similar entity. The present invention enables a prospective candidate to livestream an audiovisual audition from a kiosk or booth. The candidate's audiovisual audition is wirelessly transmitted and livestreamed to a portal. The present invention may be implemented through a kiosk, booth, or similar means of allowing the candidate to quickly livestream an audiovisual audition.

### BRIEF DESCRIPTION OF THE DRAWINGS

FIG. 1 is a flowchart depicting the overall process that is followed by the present invention.

FIG. 2 is a flowchart depicting a secondary process that is followed by the present invention.

FIG. 3 is a flowchart depicting a secondary process that is followed by the present invention.

FIG. 4 is a flowchart depicting a secondary process that is followed by the present invention.

FIG. 5 is a flowchart depicting a secondary process that is followed by the present invention.

FIG. 6 is a flowchart depicting a secondary process that is followed by the present invention.

FIG. 7 is a flowchart depicting a secondary process that is followed by the present invention.

FIG. 8 is a flowchart depicting a secondary process that is followed by the present invention.

### DETAIL DESCRIPTIONS OF THE INVENTION

All illustrations of the drawings are for the purpose of describing selected versions of the present invention and are not intended to limit the scope of the present invention.

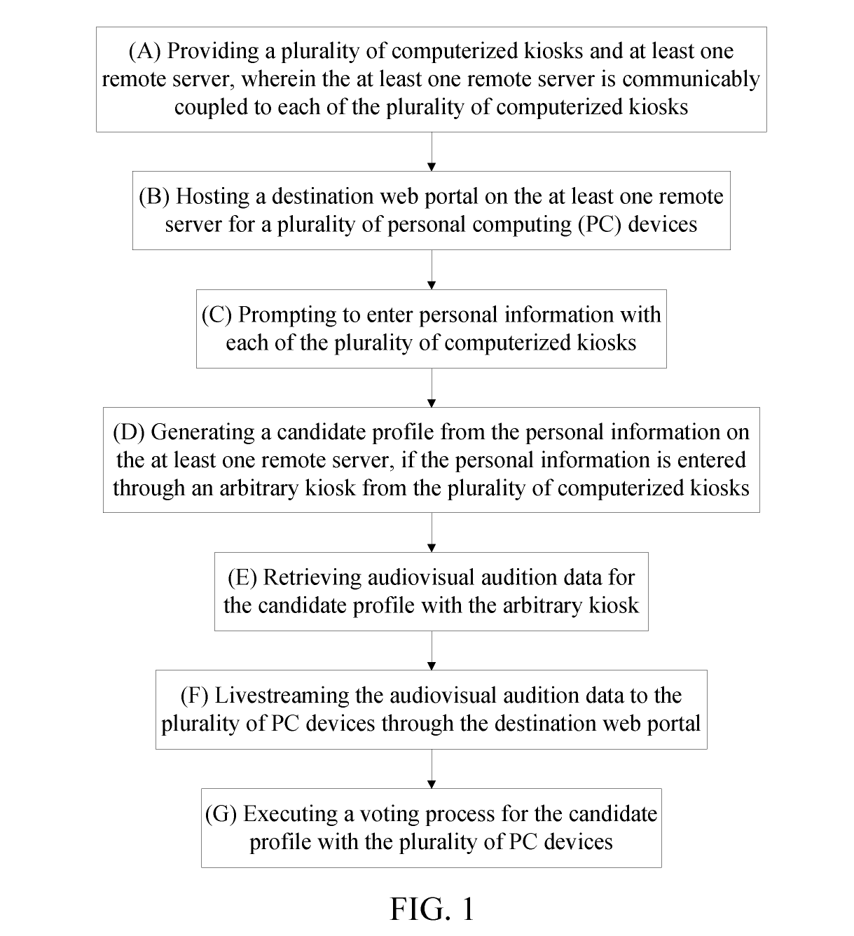

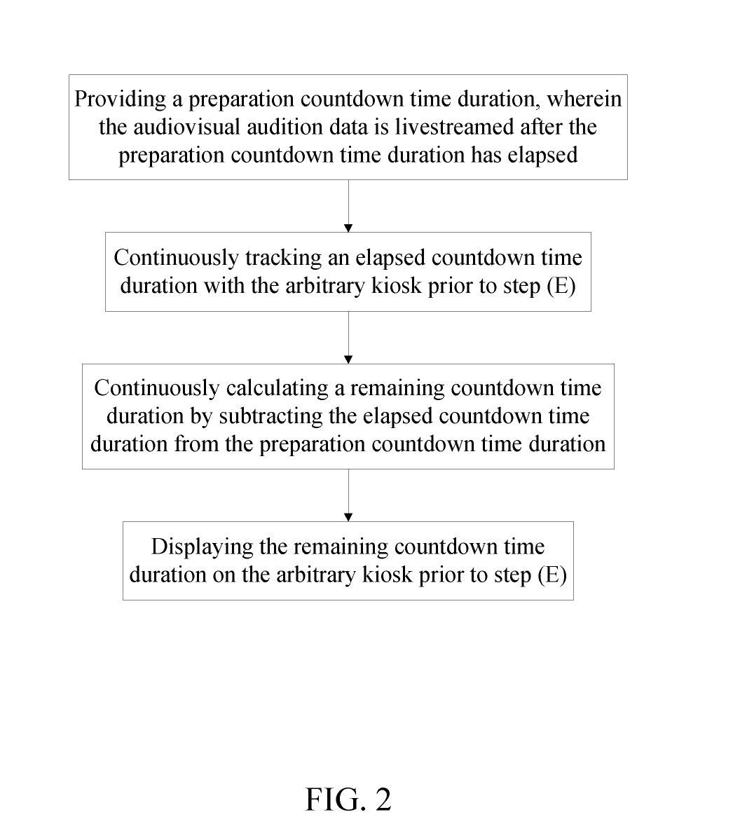

The present invention is a method of livestreaming an audiovisual audition for submission to a talent agency, talent competition, or similar entity. The overall process followed by the present invention is shown in FIG. 1 while secondary processes that are followed by the present invention are shown in FIGS. 2-8.

With reference to FIG. 1, a plurality of computerized kiosks is utilized to livestream audiovisual auditions from multiple candidates. The present invention utilizes the plurality of computerized kiosks to capture and livestream the audiovisual auditions to at least one remote server. The at least one remote server is communicably coupled to each of the plurality of computerized kiosks and serves as the destination for the audiovisual auditions that are livestreamed from the plurality of computerized kiosks.

A destination web portal is hosted on the at least one remote server for a plurality of personal computing (PC) devices. The destination web portal may be accessed by an audience for the livestreamed audiovisual auditions through the plurality of PC devices. The plurality of PC devices may include, but is not limited to, desktop computers, laptop computers, tablet computers, and smartphones.

Candidates wishing to livestream an audiovisual audition are prompted to enter personal information with each of the plurality of computerized kiosks. This relates generally to a registration process for each candidate. Personal information collected during this registration process may include, but is not limited to, name, address, and other relevant personal information. A candidate profile is generated from the personal information on the at least one remote server. The candidate profile serves as a personal overview for the candidate. The candidate profile is generated from the personal information on the at least one remote server if the personal information is entered through an arbitrary kiosk from the plurality of computerized kiosks. Audiovisual audition data is retrieved for the candidate profile with the arbitrary kiosk. The audiovisual audition data may be captured within the arbitrary kiosk via a microphone and video camera. Within the context of the present invention, audiovisual audition data refers generally to a video with audio of a candidate's audition. The candidate profile aggregates the personal information that is inputted by the candidate and is associated with the audiovisual audition data for the candidate.

The audiovisual audition data is livestreamed to the plurality of PC devices through the destination web portal. The audience is able to access the audiovisual audition data that is streamed through the destination web portal by accessing the destination web portal and selecting the corresponding candidate profile for the audiovisual audition data. A voting process is executed for the candidate profile with the plurality of PC devices, allowing the audience to vote on the candidate profile and the audiovisual audition data. In the preferred embodiment of the present invention, the voting process is utilized to determine the candidate who has accrued the most votes in a particular region or state. The top-voted candidate of each region or state is then invited to participate in a live audition by a talent agency, talent competition, or similar entity.

With reference to FIG. 2, prior to livestreaming the audiovisual audition data, a preparation countdown time duration is presented to the candidate. The preparation countdown time duration provides the candidate with sufficient time to prepare before the livestream is initiated. The audiovisual audition data is livestreamed after the preparation countdown time duration has elapsed. An elapsed countdown time duration is continuously tracked with the arbitrary kiosk before the audiovisual audition data is retrieved for the candidate profile. A remaining countdown time duration is continuously calculated by subtracting the elapsed countdown time duration from the preparation countdown time duration. The remaining countdown time duration is displayed on the arbitrary kiosk before the audiovisual audition data is retrieved for the candidate profile. The remaining countdown time duration notifies the candidate of the time remaining until the livestream of the audiovisual audition data is initiated.

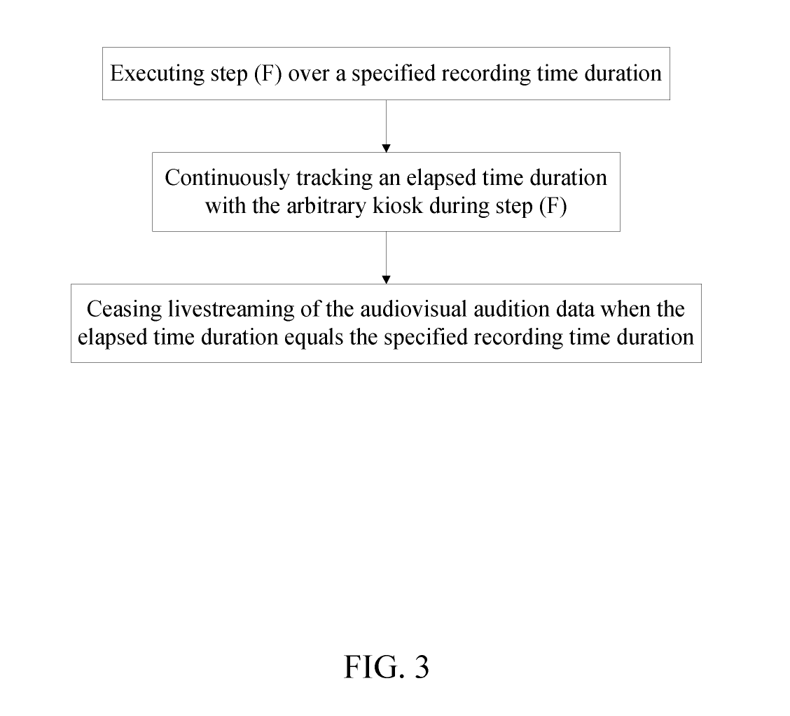

With reference to FIG. 3, the audiovisual audition data is livestreamed to the plurality of PC devices over a specified recording time duration. The specified recording time duration serves as a time limit for the candidate to livestream the audiovisual audition data. An elapsed time duration is continuously tracked with the arbitrary kiosk while the audiovisual audition data is being livestreamed. Livestreaming of the audiovisual audition data is ceased when the elapsed time duration equals the specified recording time duration, indicating that the candidate has exhausted the time limit provided to livestream the audiovisual audition data.

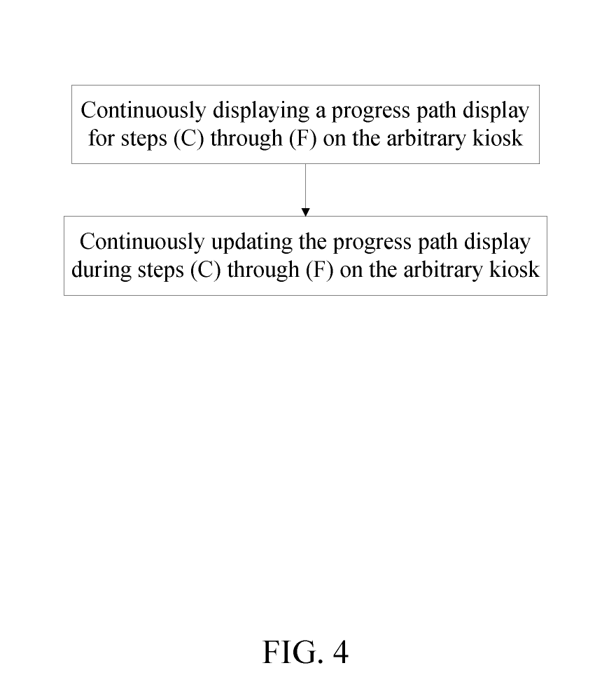

As shown in FIG. 4, a progress path display is continuously displayed on the arbitrary kiosk during the method of the present invention, allowing the candidate to be continuously aware of his or her progress throughout the process. In the preferred embodiment of the present invention, the progress path display includes the steps of entering of personal information, generating the candidate profile from the personal information, retrieving the audiovisual audition data for the candidate profile, and livestreaming the audiovisual audition data to the plurality of PC devices through the destination web portal. The progress path display is continuously updated during these steps through the arbitrary kiosk, ensuring that the candidate is aware at all times of the progress through the livestreaming process. The progress path display may include additional secondary steps of the method in addition to those previously discussed.

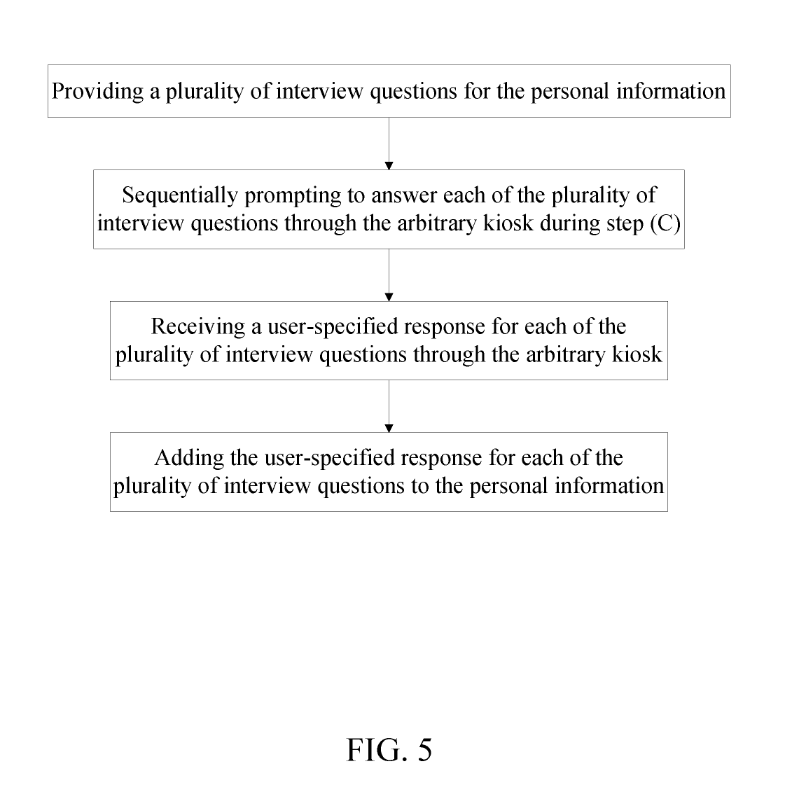

With reference to FIG. 5, the personal information may include a plurality of interview questions that is utilized to gather additional information for the candidate profile. The candidate is sequentially prompted to answer each of the plurality of interview questions through the arbitrary kiosk when entering personal information. The plurality of interview questions may be presented in text form, audio form, or visual form. A user-specified response for each of the plurality of interview questions is received through the arbitrary kiosk in order to gather additional personal information for the candidate. The user-specified response for each of the plurality of interview questions is added to the personal information to provide a more complete personal overview of the candidate.

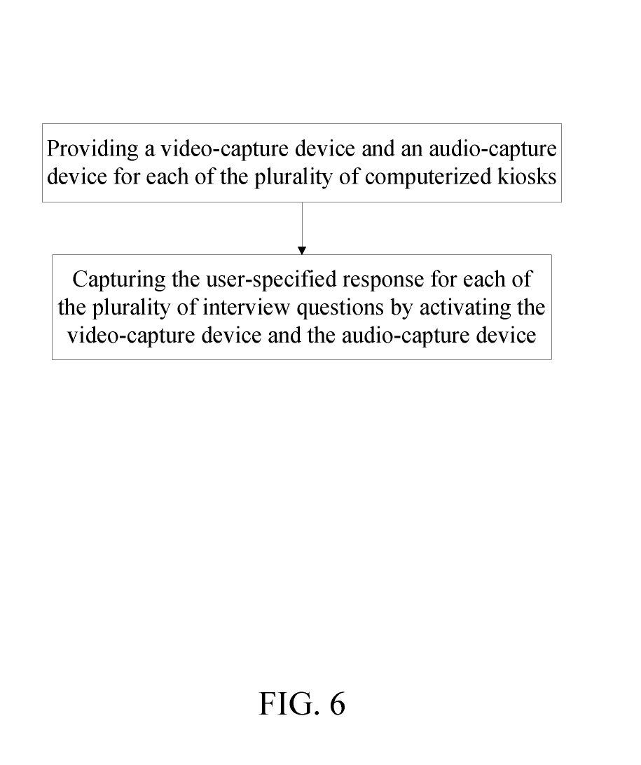

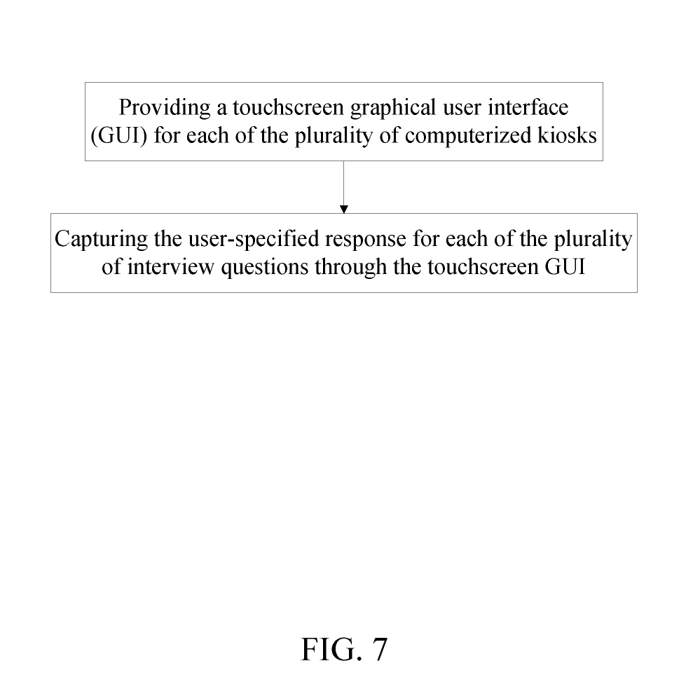

The user-specified response for each of the plurality of interview questions may be received in a number of ways. For example, as shown in FIG. 6, each of the plurality of computerized kiosks may include a video-capture device such as a camera and an audio-capture device such as a microphone. The user-specified response for each of the plurality of interview questions may be captured by activating the video-capture device and the audio-capture device. In this case, the user-specified response for each of the plurality of interview questions is captured in audiovisual form. In another example as shown in FIG. 7, each of the plurality of computerized kiosks may include a touchscreen graphical user interface (GUI). In this example, the user-specified response for each of the plurality of interview questions is captured through the touchscreen GUI. The touchscreen GUI may present an onscreen keyboard for the candidate to utilize when providing the user-specified response for each of the plurality of interview questions.

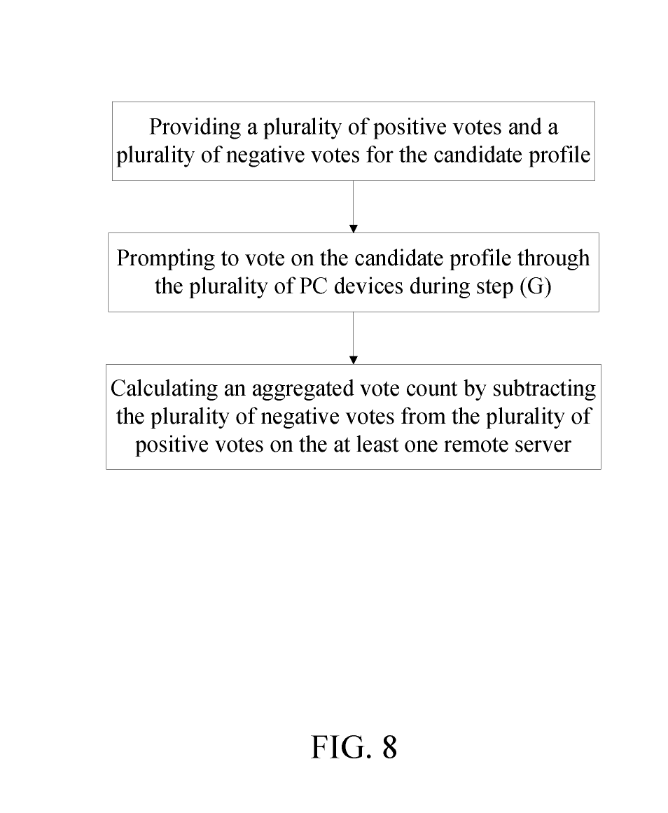

With reference to FIG. 8, during the voting process, a plurality of positive votes and a plurality of negative votes is collected from the audience voting on the candidate profile. The present invention is not limited with respect to the specific voting mechanism utilized during the voting process. For example, the plurality of positive votes may be represented in the form of “thumbs-up” or “like” icons presented along with the livestreamed audiovisual audition data. Similarly, the plurality of negative votes may be represented in the form of “thumbs-down” or “dislike” icons. During the voting process, the audience is prompted to vote on the candidate profile through the plurality of PC devices. Each audience member is able to submit a vote to the plurality of positive votes or a vote to the plurality of negative votes by selecting the desired option through the plurality of PC devices. An aggregated vote count is calculated by subtracting the plurality of negative votes from the plurality of positive votes on the at least one remote server. The aggregated vote count serves as a “final score” for the candidate profile following the voting process. In the context of the present invention, the aggregated vote count for the candidate profile is compared and ranked against the aggregated vote count for each of the additional candidate profiles within a specific region or state.

Although the present invention has been explained in relation to its preferred embodiment, it is understood that many other possible modifications and variations can be made without departing from the spirit and scope of the present invention as hereinafter claimed.

What is claimed is:

1. A method of livestreaming an audiovisual audition, the method comprises the steps of:
(A) providing a plurality of computerized kiosks and at least one remote server, wherein the at least one remote server is communicably coupled to each of the plurality of computerized kiosks;
(B) hosting a destination web portal on the at least one remote server for a plurality of personal computing (PC) devices;
(C) prompting to enter personal information with each of the plurality of computerized kiosks;
(D) generating a candidate profile from the personal information on the at least one remote server, if the personal information is entered through an arbitrary kiosk from the plurality of computerized kiosks;
(E) retrieving audiovisual audition data for the candidate profile with the arbitrary kiosk;
(F) livestreaming the audiovisual audition data to the plurality of PC devices through the destination web portal; and
(G) executing a voting process for the candidate profile with the plurality of PC devices.

2. The method of livestreaming an audiovisual audition as claimed in claim 1, the method comprises the steps of:
providing a preparation countdown time duration, wherein the audiovisual audition data is livestreamed after the preparation countdown time duration has elapsed;
continuously tracking an elapsed countdown time duration with the arbitrary kiosk prior to step (E);
continuously calculating a remaining countdown time duration by subtracting the elapsed countdown time duration from the preparation countdown time duration; and
displaying the remaining countdown time duration on the arbitrary kiosk prior to step (E).

3. The method of livestreaming an audiovisual audition as claimed in claim 1, the method comprises the steps of:
executing step (F) over a specified recording time duration;
continuously tracking an elapsed time duration with the arbitrary kiosk during step (F); and
ceasing livestreaming of the audiovisual audition data when the elapsed time duration equals the specified recording time duration.

4. The method of livestreaming an audiovisual audition as claimed in claim 1, the method comprises the steps of:
continuously displaying a progress path display for steps (C) through (F) on the arbitrary kiosk; and
continuously updating the progress path display during steps (C) through (F) through the arbitrary kiosk.

5. The method of livestreaming an audiovisual audition as claimed in claim 1, the method comprises the steps of:
providing a plurality of interview questions for the personal information;
sequentially prompting to answer each of the plurality of interview questions through the arbitrary kiosk during step (C);
receiving a user-specified response for each of the plurality of interview questions through the arbitrary kiosk; and
adding the user-specified response for each of the plurality of interview questions to the personal information.

6. The method of livestreaming an audiovisual audition as claimed in claim 5, the method comprises the steps of:
providing a video-capture device and an audio-capture device for each of the plurality of computerized kiosks; and
capturing the user-specified response for each of the plurality of interview questions by activating the video-capture device and the audio-capture device.

7. The method of livestreaming an audiovisual audition as claimed in claim 5, the method comprises the steps of:
providing a touchscreen graphical user interface (GUI) for each of the plurality of computerized kiosks; and
capturing the user-specified response for each of the plurality of interview questions through the touchscreen GUI.

8. The method of livestreaming an audiovisual audition as claimed in claim 1, the method comprises the steps of:
providing a plurality of positive votes and a plurality of negative votes for the candidate profile;
prompting to vote on the candidate profile through the plurality of PC devices during step (G); and
calculating an aggregated vote count by subtracting the plurality of negative votes from the plurality of positive votes on the at least one remote server.
